(19) United States
(12) Patent Application Publication
(10) Pub. No.: US 2021/0283814 A1
(43) Pub. Date: Sep. 16, 2021

(54) METHOD OF PROCESSING SOLID POLYMER PARTICLES OF A POLYCONDENSATE BY MEANS OF A MULTI-ROTATION SYSTEM

(71) Applicant: Gneuss GmbH, Bad Oeynhausen (DE)

(72) Inventors: Daniel GNEUSS, Charlotte, NC (US); Detlef GNEUSS, Carabietta (CH); Stephan GNEUSS, Bad Oeynhausen (DE)

(73) Assignee: Gneuss GmbH, Bad Oeynhausen (DE)

(21) Appl. No.: 17/334,074

(22) Filed: May 28, 2021

Related U.S. Application Data
(63) Continuation of application No. PCT/DE2019/101020, filed on Nov. 28, 2019.

(30) Foreign Application Priority Data
Nov. 28, 2018 (DE) 10 2018 130 102.2

(51) Int. Cl. B29C 48/45; B29C 48/76; B29C 48/92; B29C 48/44; B29C 48/80; B29C 48/27; B29C 48/425; B29C 48/68

(52) U.S. Cl. CPC B29C 48/45; B29C 48/767; B29C 48/92; B29C 48/44; B29C 2948/924; B29C 48/2715; B29C 48/425; B29C 48/683; B29C 2948/92019; B29C 48/832

(57) ABSTRACT

A method of processing solid polymer particles of a poly condensate by a multi-rotation system. Polymer particles are melted in a first extruder section having an extruder screw that rotates. The partly molten polymer mass containing between 5% by volume and 50% by volume of unmolten polymer particles is passed into a second extruder section with a poly-rotation unit and multiple satellite screws that rotate therein. A diameter of the poly-rotation unit is increased compared to the screw diameter of the first extruder section and a transition cone is formed between the extruder sections and a conical gap is formed with respect to the housing. Ambient pressure plastification of the remaining polymer particles is performed by passage through a drive zone. The polymer mass is guided completely molten in the drive zone onward through a venting zone under reduced pressure.

This nonprovisional application is a continuation of International Application No. PCT/DE2019/101020, which was filed on Nov. 28, 2019 and which claims priority to German Patent Application No. 10 2018 130 102.2, which was filed in Germany on Nov. 28, 2018 and which are both herein incorporated by reference.

### BACKGROUND OF THE INVENTION

### Field of the Invention

The present invention relates to a method for processing solid plastics particles from a polycondensate by means of a multi-rotation system.

### Description of the Background Art

A basic problem when processing polycondensates, especially hydrolyzable plastics such as PET, in an extrusion process is that a certain residence time and a certain heat input per unit of time are required in order to obtain a homogeneous plastics melt that can be processed further, but on the other hand it is precisely this heat input during the residence time that causes the hydrolytic degradation of the plastic if it contains moisture. Particularly in recycling processes, however, complete drying of the solid matter before it is fed into the extrusion process would be uneconomical, with the result that PET recycling material must always be regarded as moist. Therefore, solid plastic that contains residual moisture is drawn into an extruder, melted and degassed in order to remove water as condensate and, as a result, to stop hydrolytic degradation or even to set a viscosity-increasing reverse reaction in motion.

A significant improvement in this context is the multi-rotation system described in WO 2003 033 240 A1, which corresponds to US 2005/0047267, which is incorporated herein by reference, in which the multi-rotation system contains an extruder screw that comprises a so-called poly-rotation unit between a feed and metering zone for drawing in and melting the plastic and a discharge zone. The poly-rotation unit has a diameter that is significantly larger than the other zones, and also has a plurality of rotating satellite screws. With the multi-rotation system, a significant increase in the degassing performance compared with single-screw and twin-screw systems is achieved. As a result, the residence time of the plastics melt in the poly-rotation unit can be kept very short.

A problem remains in the conventional art that, with higher moisture contents, extensive hydrolytic degradation has already set in in the metering zone, which can often no longer be compensated for subsequently in the poly-rotation unit. In any case, the potential that the poly-rotation unit has for increasing the intrinsic viscosity can be used in the overall process only to completely or partially eliminate the previous damage, without however achieving any improvement beyond the initial properties of the processed plastic.

In order to reduce the residence time of the plastic in the metering zone, the screw would have to rotate faster, as a result of which on the other hand more shear is exerted and the heat input per unit of time increases. This in turn favors the chemical degradation process and additionally damages the plastic through shear effects. In theory, although it would also be conceivable to keep the screw rotation speed low and to keep the metering zone short, the external heating power in the extruder section would then have to be increased significantly so that the plastic is melted in the first place, such that it is even possible for the plastic to be burned at the edges. The only known way out of the described dilemma consists in a more intensive inline pre-drying of the drawn-in solid matter before it is fed into the extruder, with correspondingly disadvantageous expenditure of time and costs.

### SUMMARY OF THE INVENTION

It is therefore an object of the present invention to provide a method for processing solid plastics particles from a polycondensate by means of a multi-rotation system with which a reduction in the intrinsic viscosity in the processing process is slowed down or avoided or with which the intrinsic viscosity is even increased.

Surprisingly, it was found according to the invention that a significant improvement in the problem described is achieved by ignoring conventional ideas of the person skilled in the art regarding the metering process in the extruder. According to the usual expert opinion, for example the pressure in the extruder is an important variable that influences the melting behavior. In addition, the aim has hitherto always been to transfer only a completely melted and homogenized plastics melt to the next processing stage.

The invention takes a significantly different route here. A key feature of the method according to the invention is that the plastics melt still contains clearly visible proportions of non-melted plastics particles when it is transferred from the feed and metering zone. The proportions of the solid matter are at least 5%, preferably even more than 10%. The upper limit should be selected at 40% to 50% solids fraction. Because according to the invention it is tolerated not to completely melt and homogenize the plastic before it is degassed, the heat input in the metering zone can be reduced, for example through reduced external heating, slower rotation of the screw, shorter design of the first extruder section and/or internal cooling of the extruder screw.

A further advantageous feature is that the still solid plastics particles are melted largely by shock heating in the second extruder section, specifically just before the housing openings to which the vacuum suction is connected. Shock heating is achieved by directing the plastics melt with the still solid particles over the drive shafts of the satellite screws. These mesh in a toothing in the housing bore. The fact that the solid particles are guided through the toothing creates a high level of local friction and crushing, which not only plasticizes the remaining solid particles very quickly but also additionally heats up the already melted mass fractions in the surrounding area. Since the toothings do not cover the entire circumference of the poly-rotation unit, the entire volume of plastics melt is also not guided through the toothings, but rather flows also form through bypasses running past said toothings. However, the effect of the local shock heating also extends into the neighboring regions of the toothings.

By defining the length of the drive pinions, in particular in relation to the total length of the poly-rotation unit or to the degassing zone as the process-relevant part thereof, the extent of the shock heating can be influenced. According to the invention, an MRS extruder is thus preferably used, in which the torque to be transmitted in each case to the satellite screw forms only the lower limit for the pinion length, but otherwise the pinion length can be selected to be significantly longer than necessary from a strength point of view in order to achieve and reinforce the effects described above. Length ratios of 1:40 to 1:6 have proven to be particularly suitable, the pinion length being set in each case in relation to the length of the degassing zone immediately following the drive.

The shock heating takes place immediately before the plastics melt enters the vacuum degassing zone. This means that the residence time of the significantly heated and now completely melted plastic, which still contains moisture, up to the entry into the degassing zone is negligibly short, with the result that the exposure time of the moisture to the plastics melt is reduced to a fraction.

Finally, the invention ignores the view that the melting and homogenization of plastic in the extruder must always take place under high pressure. In fact, in the method according to the invention, there is a high pressure only in the region of the transition cone between the first and the second extruder section. This is followed in spatial proximity by the toothed drive region and, in turn, adjacent to this is the vacuum influence zone. This means that the relatively high build-up pressure that is still present at the transition cone has already been completely reduced after a short axial path along the extruder screw, said path making up significantly less than half, in particular less than 20%, of the length of the poly-rotation unit. Already in the region of the drive toothing of the satellite screws, where the shock heating takes place, the pressure in the plastics melt is almost completely reduced; it is at least already reduced there to such a residual pressure that it is no longer relevant for the plasticizing behavior. In this sense, in the method according to the invention, “pressureless plasticization” of the solid particles initially entrained in the plastics melt is effected in the region of the toothing of the satellite screws and the subsequent length regions up to the entry into the vacuum window.

In short, as it were, a supercooled plastics melt is generated in the first extruder section, because as yet not all the volume fractions have been heated up to above the plastics melt temperature of the processed plastic there. It is only very shortly before entering the vacuum zone that the supercooled plastics melt is reheated to such an extent that the remaining particles melt and thereby release the stored residual moisture. The water evaporating from the remaining particles is then immediately suctioned away in the vacuum zone before it can even develop its hydrolyzing effect.

This achieves the below essential effects which, when carrying out the method according to the invention, greatly reduce the hydrolytic degradation of the plastics melt and the damage to the plastics melt due to shear during processing.

If water is released during melting in the first extruder section, it can develop its damaging effect only at a low temperature level, because the temperature there is deliberately kept at the threshold of the melting temperature. The hydrolysis is thus at least slowed down.

In order to reduce the heat input, the screw rotation speed in the first extruder section can be kept low; this also reduces the adverse effect due to shear.

Some of the moisture contained in the plastics particles is not even released in the first extruder section, but rather is transported to the next section via the remaining solid matter as vehicle. There, release and suction take place virtually simultaneously.

It is true that the plastics melt is also subjected to significant shear when it is passed through the drive toothing. However, because immediately afterwards the influence of the vacuum begins, whereby water is removed as condensate, and because the temperature is also sufficiently high, the polycondensation reaction can start, which leads to the molecule chain extension and repairs the damage.

So that the method according to the invention can be carried out in the manner described and the advantageous effects are achieved, there is in particular a manipulated variable that has to be specifically monitored and, if necessary, readjusted. In this case, said manipulated variable is the gap width at the transition cone or the associated build-up pressure. In the case of a gap that is too narrow, the build-up pressure increases to such an extent that the conveying capacity of the extruder screw in the first extruder section is not sufficient to transfer a constant volume flow into the second extruder section. In this case, the residence time in the first extruder section would increase sharply, which is precisely what is to be avoided.

By contrast, a gap that is too wide increases the flow rate in the first extruder section. This would, however, wash excessively high solids fractions into the following section, which could overload the satellite screw drive there and lead to blockages or even damage to the toothings.

The aim of the procedure according to the invention is thus, on the one hand, to transfer as much solid matter as possible in order to transport the moisture therein, as it were in encapsulated form, into the next section and only release it very late, close to the suction. On the other hand, however, the solids content is intended to be kept low enough that the pinions are not blocked or even non-melted particles are conducted through and leave the multi-rotation system on the discharge side.

The appropriate gap width of the conical gap can be structurally predefined as a function of the expected viscosity of the plastics melt at the transition cone or can be fixedly set before the method is carried out.

In a multi-rotation system which is preferred for carrying out the method and which has the features of claim 8, the gap width can be adjusted via an axial displacement of the extruder screw in relation to the housing while the method is being carried out.

To this end, an active control unit can be provided which, as a function of a pressure measured at a pressure sensor upstream of the transition cone, actuates an actuator such as a hydraulic cylinder and moves the extruder screw. At high pressure, the extruder screw is pushed slightly forward in the flow direction, such that the gap widens. If the pressure drops too far, the opposite movement is forced.

The pressure at the transition cone of a multi-rotation system fluctuates greatly in practice and reaches values from 20 bar to 150 bar. In the desired normal operation, the pressure is preferably between 40 bar and 60 bar.

Based on the example of a multi-rotation system with a diameter of 130 mm for the drawing-in screw and a rotor diameter of 225 mm for the poly-rotation unit, the gap width is typically for example 5 to 10 mm, an additional adjustment path being provided on both sides in order to be able to react to dynamically adjusting operating conditions.

A simple but effective measure is to support the extruder screw on the housing via at least one spring element, in particular via a plate spring. The spring element is subjected to tensile load, this is because in a multi-rotation system the extruder screw is always supported towards the entry due to the pressure at the tip of the metering zone, which acts on the cone. As a result, the extruder screw is specifically not pressed towards the entry, as is otherwise usual in single-screw extruders, but rather towards the discharge. It should also be taken into account that the spring element can be arranged only outside of the parts conducting the plastics melt and therefore cannot be positioned on the discharge side. Rather, the spring element must be positioned during driving for the rotation of the extruder screw and hold said screw in place on the housing, as it were, with said spring element being subject to tension. The spring element lies between a stationary part and a co-rotating part. The stationary part is connected to the gear mechanism via a thread, and the entire worm structure can thus be moved axially by way of this thread. If the build-up pressure at the transition cone between extruder sections one and two increases too much, the extruder screw moves axially forward, such that the build-up gap widens. Conversely, a decrease in the build-up pressure on account of the spring force leads to a narrowing of the gap again. This creates an equilibrium between the spring force and the propulsive force caused by the build-up pressure at the transition cone. Due to the high masses and the viscosity of the plastics melt, a spring-damper system is formed which does not require additional damping elements and which is sufficiently inert to avoid vibrations.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a detail of a multi-rotation system in section; and

FIG. 2 shows a side view of an extruder screw and a pressure and temperature profile over the length thereof.

### DETAILED DESCRIPTION

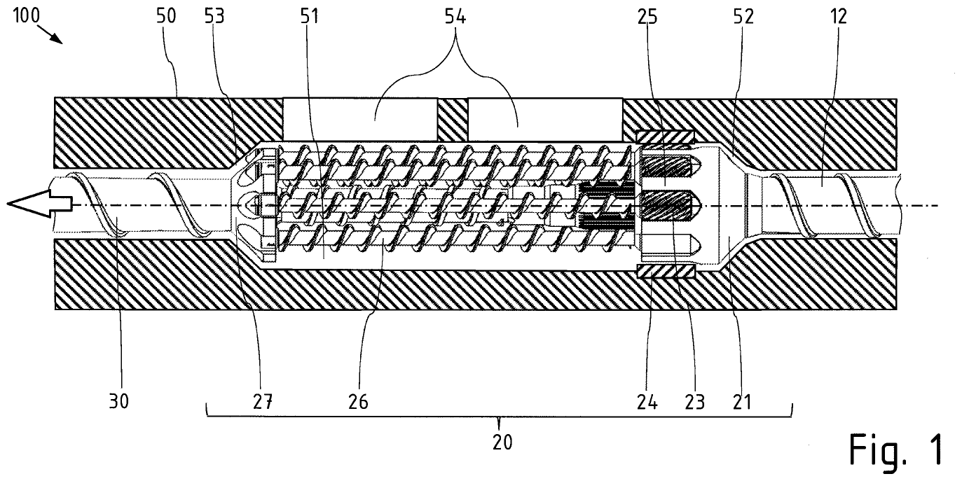

FIG. 1 illustrates a detail of a multi-rotation system 100. Arranged in a housing recess 51 in a housing 50 is an extruder screw which is divided into different zones. A poly-rotation unit 20 is arranged between a metering zone 12, which serves to homogenize the previously drawn-in and at least partially melted plastics particles, and a discharge zone 30, in which the completely treated plastics melt is conveyed away.

A transition cone 21 is formed at the transition from the metering zone 12; a conical gap 52 forms towards the housing 50.

This is followed by a drive zone in which pinions 23 of satellite screws 26 run in a rotary ring 24 which is connected to the housing and which has an internal toothing 24. Passages 25 are located between the pinions 23.

The satellite screws 26 rotate themselves, while the entire extruder screw rotates, and thus also the rotor in which they are mounted. They extend over the substantial part of the length of the poly-rotation unit 20 and are guided past housing windows 54, to which a vacuum is applied.

The satellite screws 26 are mounted with their front tips in a bearing carrier 27, in which a cone is again provided in order to return from the widened diameter of the poly-rotation unit 20 to the smaller diameter of the discharge zone 30. A further conical gap 53 is correspondingly formed there.

The structural design of the multi-rotation system 100 differs according to the invention in that the width of the conical gap 52 can be adjusted by way of an axial displacement of the entire extruder screw in relation to the housing 50 in order to utilize the gap width specifically for pressure control and thus to influence the proportion of solids fractions that have not yet melted and are flushed out via the transition cone 21.

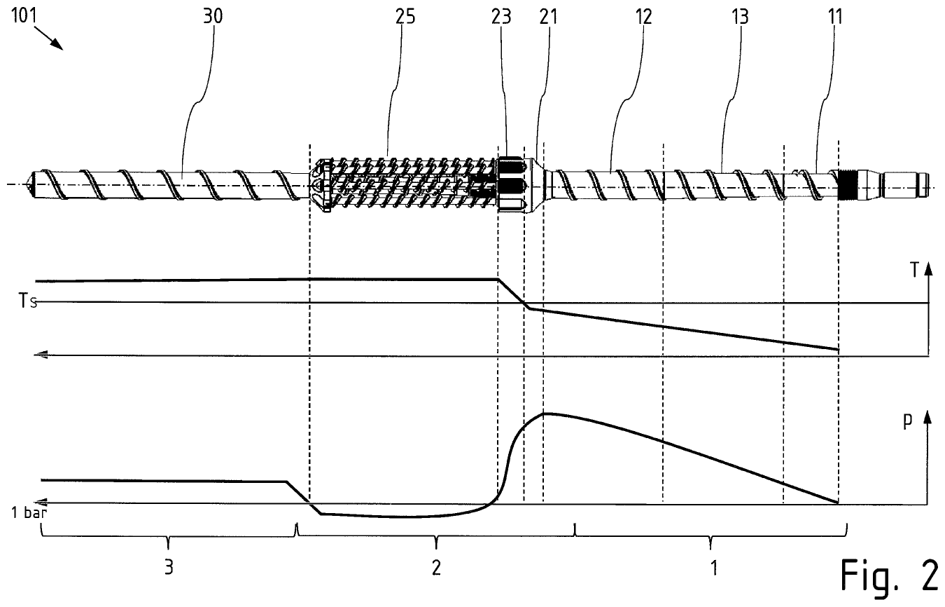

For understanding of the method according to the invention, FIG. 2 illustrates the qualitative profile of the pressure p and the temperature T with respect to the axial extent of the extruder screw 101 with its various sections 1, 2, 3.

In a feed and metering extruder section 1, solid matter is first drawn in in a feed zone 11. Pressure is built up in a compression zone 13. In the following metering zone 12, the drawn-in plastic is at least partially melted and homogenized. According to the invention, however, only part of the solid matter is melted and homogenized, while another part of 5% to 50%, in particular 10% to 40%, remains as solid matter in the plastics melt.

In the temperature profile of FIG. 2, an average melt temperature is illustrated, that is to say approximately the average of the respective temperature of proportions of the melted plastic that are in direct contact with the extruder screw and those portions that are in contact with the inner wall of the housing. According to the invention, however, solid mass fractions with a correspondingly lower core temperature are still contained therein, such that the result is that the average melt temperature of the processed plastic in the feed and metering extruder section 1 lies below a melting temperature Ts.

The method is advantageous in particular for processing polyester. Here, the melting temperature is 235° C. to 260° C., depending on the degree of crystallization.

In order to obtain such a supercooled plastics melt, the extruder screw 101 is cooled at least in the feed and metering extruder section 1. For this purpose, the heat carrier used is in particular oil with a supply temperature between 90° C. and 130° C. At the same time, the housing wall (not illustrated in FIG. 2) is heated, for example to 280° C. The simultaneous heating and cooling in the same section 1 is not contradictory. The internal cooling serves to dissipate the partial heat output introduced by the rotation of the extruder screw 101, said heat output usually being higher at this point than required for the procedure. This is because the screw rotation speed must be matched to the rotation speed required in the multi-shaft extruder section 2 and can therefore not be reduced for the extruder section 1. By contrast, the heating on the housing serves to generate a lubricating film of molten plastic independently of the proportion of solid matter in the plastics melt conveyed.

The temperature rises slightly due to the heat input as a result of the rotation of the extruder screw 101 during the transition to the multi-shaft extruder section 2, but the average temperature of the plastics volume conveyed is preferably still slightly below the melting temperature Ts. Only in the drive zone, that is to say during passage through the region of the drive pinions 23, does the temperature rise abruptly, specifically significantly above the plastics melt temperature Ts. The plastic is therefore only completely melted and brought to a temperature level exactly where moisture and contamination can be extracted by means of the applied vacuum and the intrinsic viscosity can be increased by promoting the polycondensation reaction.

The further temperature profile in the discharge extruder section 3, downstream of the multi-shaft extruder section 2, is no longer important for the quality of the processing, but is constantly above the melting temperature Ts.

In addition, the pressure profile of the plastics melt in the extruder is plotted over the length of the extruder screw 101 in FIG. 2. The example shown is an extruder screw 101 in the case of which the feed zone 11 is not grooved, such that a pressure which rises only gradually from there to the transition cone 21 results.

Downstream of the transition cone 21, there are no longer any conveying elements on the extruder screw 101, with the result that a pressure drop occurs immediately. The pressure drops to a vacuum level of virtually zero in the case of the satellite screws 26. In the drive zone with the pinions 23 which is immediately upstream thereof in the flow direction, there is already no longer any significant pressure, such that the shock heating of the plastics composition, which takes place there and which causes the plasticization of the remaining solids fractions, takes place virtually in a pressureless manner.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for processing solid plastics particles from a polycondensate via a multi-rotation system, the method comprising:
drawing in of the plastics particles and at least partial melting of the plastics particles in a first extruder section with at least one extruder screw rotating in a housing recess of a housing;
transferring the at least partially melted plastics composition into a second extruder section, which is designed as a multi-screw extruder section with a poly-rotation unit and a plurality of satellite screws rotating therein, a diameter of the poly-rotation unit being increased compared with the screw diameter of the first extruder section and a transition cone being formed between the extruder sections and a conical gap being formed in relation to the housing, the partially melted plastics composition as supercooled plastics melt contains between 5% by volume and 50% by volume of non-melted and non-dehumidified plastics particles;
forwarding the plastics composition which has been completely melted in the drive zone through a degassing zone in which a vacuum is applied;
removing volatile constituents from the plastics melt in the degassing zone;
transferring the plastics melt into a discharge extruder section;
subjecting the remaining plastics particles to pressureless plasticization by at least parts of the plastics composition being passed through a drive zone that is located downstream of the transition cone in a flow direction and which has exposed drive pinions of the satellite screws; and
reheating, very shortly before entering the vacuum zone, the supercooled plastics melt to such an extent that the remaining plastics particles melt and thereby release the stored residual moisture.

2. The method as claimed in claim 1, wherein the solid plastics particles are melted by shock heating when they are passed through the drive zone.

3. The method as claimed in claim 1, wherein the partially melted plastics composition contains between 10% by volume and 40% by volume of non-melted residual particles when it is transferred from the first to the second extruder section.

4. The method as claimed in claim 1, wherein the feed and metering zone of the extruder screw is temperature-controlled by a fluid flowing in the interior thereof which has an supply temperature that lies between the glass transition temperature and the melting temperature Ts of the plastic of which the plastics particles are composed.

5. The method as claimed in claim 1, wherein the filling level in the multi-screw extruder section is less than 100%.

6. The method as claimed in claim 1, wherein a width of a conical gap between the transition cone of the extruder screw and the housing recess is adjusted via an axial displacement of the extruder screw in relation to the housing.

7. The method as claimed in claim 6, wherein the width of the conical gap is adjusted as a function of the pressure at the end of the metering zone of the first extruder section, a high pressure leading to an opening of the conical gap and a low pressure leading to a narrowing of the conical gap.

8. The method as claimed in claim 6, wherein the axially displaceably arranged extruder screw is supported on an upstream spring element on the housing and the extruder screw is damped by the viscosity of the melt in which it is mounted.

9. A multi-rotation system for carrying out the method as claimed in claim 1, the system comprising:
at least one housing with a housing recess which has at least one housing opening in a degassing zone in which a vacuum is applied;
an extruder screw which is rotable in the housing recess;
a first extruder section with at least one feed zone and metering zone on the extruder screw;
a second extruder section, which is designed as a multi-screw extruder section with a poly-rotation unit and a plurality of satellite screws rotating therein, a diameter of the poly-rotation unit being increased compared with the screw diameter in the first extruder section;
a transition cone which is formed between the extruder sections on the extruder screw;
a conical gap formed between the transition cone and the housing recess, the conical gap being adjustable via an axial displacement of the extruder screw in relation to the housing;
a drive zone which is located downstream of the transition cone in the flow direction and which has exposed drive pinions of the satellite screws; and
a discharge extruder section.

10. The multi-rotation system as claimed in claim 9, wherein a ratio of the length of the pinions of the satellite screws to the axial extent of the degassing zone is 1:40 to 1:6.

11. The multi-rotation system as claimed in claim 9, further comprising:
at least one pressure sensor which is arranged upstream of the transition cone in the metering zone;
an adjusting device via which the extruder screw is displaceable axially in relation to the housing; and
a control unit which is connected to the pressure sensor and the actuating device.

12. The multi-rotation system as claimed in claim 9, wherein provided upstream of the feed zone is a spring element via which the extruder screw is supported on the housing.

13. The multi-rotation system as claimed in claim 9, wherein the extruder screw is adapted to be temperature-controlled at least in the first extruder section by a fluid flowing in an inner flow channel.

14. The multi-rotation system as claimed in claim 9, wherein the housing is adapted to be temperature-controlled at least in the first and second extruder sections.

15. The multi-rotation system as claimed in claim 9, wherein a discharge zone of the extruder screw has a diameter that is reduced compared with the poly-rotation unit.
